(19) United States
(12) Patent Application Publication
(10) Pub. No.: US 2016/0379229 A1
(43) Pub. Date: Dec. 29, 2016

(54) PREDICTING PROJECT OUTCOME BASED ON COMMENTS

(71) Applicant: International Business Machines Corporation, Armonk, NY (US)

(72) Inventors: Rama Akkiraju, Yorktown Heights, NY (US); Daniel B. Greenia, Mountain View, CA (US); Hamid R. Motahari Nezhad, San Jose, CA (US); Taiga Nakamura, Santa Clara, CA (US)

(21) Appl. No.: 14/750,140

(22) Filed: Jun. 25, 2015

(51) Int. Cl. G06Q 30/02; G06F 17/30

(52) U.S. Cl. CPC G06Q 30/0203; G06F 17/30707; G06F 17/30687; G06Q 30/0282

(57) ABSTRACT

In one embodiment, a computer-implemented method includes receiving a set of comments related to a project. One or more sentiment tags are extracted from the set of comments, where each sentiment tag includes an associated sentiment phrase. One or more sentiment scores are assigned to the one or more sentiment tags, with a sentiment score being assigned to each associated sentiment tag. The sentiment score for an associated sentiment tag is selected to represent the strength and polarity of the associated sentiment phrase. The one or more sentiment tags and the one or more sentiment scores are mapped, by a computer processor, to a first prediction for the project.

### STATEMENT REGARDING PRIOR DISCLOSURE BY THE INVENTOR OR A JOINT INVENTOR

The following disclosure is submitted under 35 U.S.C. 102(b)(1)(A):

DISCLOSURE: Hamid R. Motahari Nezhad, Daniel B. Greenia, Taiga Nakamura and Rama Akkiraju; “Health Identification and Outcome Prediction for Outsourcing Services Based on Textual Comments”; Service Computing—IEEE SCC 2014; Jun. 27, 2014.

### BACKGROUND

Various embodiments of this disclosure relate to text analysis for project proposals and, more particularly, to predicting a project's outcome based on textual comments.

A common practice in some industries is the preparation of project proposals, sometimes in response to requests for proposals (RFPs). A project proposal may include information such as estimated cost and timeframe for completing a project. When preparing a proposal, it is useful for an organization to be able to predict the outcome of the project for which the proposal is being prepared. For instance, if it is predicted that the outcome will be a project that ends up being over-budget, then the organization may want to modify features of the proposal or may opt not to send the proposal as a response to an RFP.

### SUMMARY

In one embodiment of this disclosure, a computer-implemented method includes receiving a set of comments related to a project. One or more sentiment tags are extracted from the set of comments, where each sentiment tag includes an associated sentiment phrase. One or more sentiment scores are assigned to the one or more sentiment tags, with a sentiment score being assigned to each associated sentiment tag. The sentiment score for an associated sentiment tag is selected to represent the strength and polarity of the associated sentiment phrase. The one or more sentiment tags and the one or more sentiment scores are mapped to a first prediction for the project.

In another embodiment, a system includes a memory having computer readable instructions, and a processor for executing the computer readable instructions. The computer readable instructions include receiving a set of comments related to a project. Further according to the computer readable instructions, one or more sentiment tags are extracted from the set of comments, where each sentiment tag includes an associated sentiment phrase. One or more sentiment scores are assigned to the one or more sentiment tags, with a sentiment score being assigned to each associated sentiment tag. The sentiment score for an associated sentiment tag is selected to represent the strength and polarity of the associated sentiment phrase. The one or more sentiment tags and the one or more sentiment scores are mapped to a first prediction for the project.

In yet another embodiment, a computer program product for predicting a project outcome includes a computer readable storage medium having program instructions embodied therewith. The program instructions are executable by a processor to cause the processor to perform a method. The method includes receiving a set of comments related to a project. Further according to the method, one or more sentiment tags are extracted from the set of comments, where each sentiment tag includes an associated sentiment phrase. One or more sentiment scores are assigned to the one or more sentiment tags, with a sentiment score being assigned to each associated sentiment tag. The sentiment score for an associated sentiment tag is selected to represent the strength and polarity of the associated sentiment phrase. The one or more sentiment tags and the one or more sentiment scores are mapped to a first prediction for the project.

Additional features and advantages are realized through the techniques of the present invention. Other embodiments and aspects of the invention are described in detail herein and are considered a part of the claimed invention. For a better understanding of the invention with the advantages and the features, refer to the description and to the drawings.

### BRIEF DESCRIPTION OF THE DRAWINGS

The subject matter which is regarded as the invention is particularly pointed out and distinctly claimed in the claims at the conclusion of the specification. The forgoing and other features, and advantages of the invention are apparent from the following detailed description taken in conjunction with the accompanying drawings in which:

FIG. 1 is a block diagram of a prediction system, according to some embodiments of this disclosure;

FIG. 2 is a flow diagram of a method for training a sentiment-based prediction model, according to some embodiment of this disclosure;

FIG. 3 is a flow diagram of a method for training a text-based prediction model, according to another embodiment of this disclosure;

FIG. 4 is a flow diagram of a method for predicting a project's outcome, according to some embodiments of this disclosure; and

FIG. 5 is a block diagram of another prediction system, according to some embodiments of this disclosure;

FIG. 6 is a block diagram of yet another prediction system, according to some embodiments of this disclosure;

FIG. 7 is a flow diagram of a method for training an entity weight model, according to some embodiment of this disclosure;

FIG. 8 is a flow diagram of a method for calculating a project's health score, according to some embodiments of this disclosure; and

FIG. 9 is a block diagram of a computing device for implementing some or all aspects of the prediction system, according to some embodiments of this disclosure.

### DETAILED DESCRIPTION

Various embodiments of this disclosure are prediction systems for predicting the outcome of a project based on textual comments related to the progress of the project. Some embodiments may apply to the project at the proposal phase, thus enabling the people working on the proposal to determine whether the project is truly worthwhile or to adjust the proposal accordingly.

An existing mechanism for predicting project outcomes is to analyze keywords in comments related to the project. However, using textual comments and text classification by itself does not yield a high-quality predictor model. Embodiments of this disclosure address this issue.

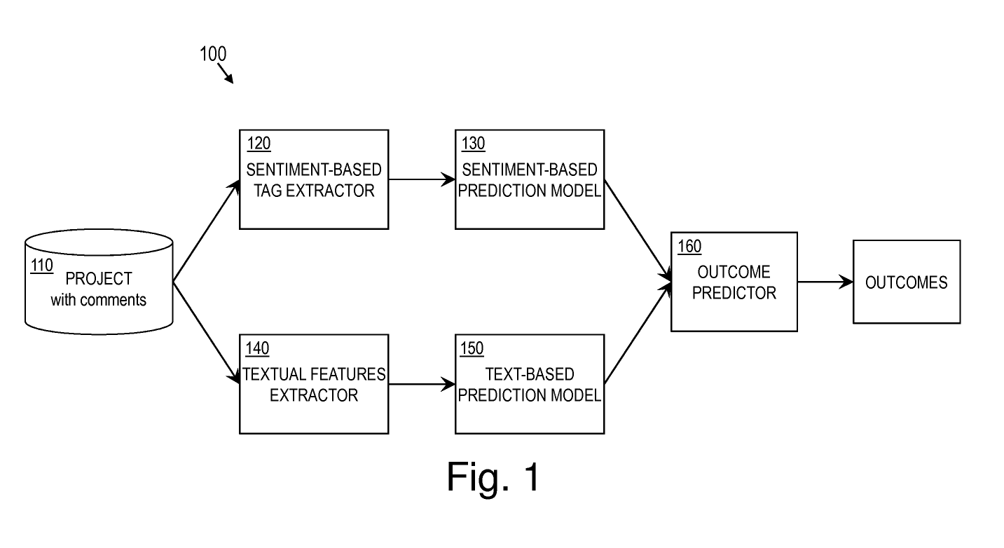

FIG. 1 is a block diagram of a prediction system 100, according to some embodiments of this disclosure. As shown, the prediction system 100 may apply to a project 110 that has comments and may include a sentiment-based tag extractor 120, a sentiment-based prediction model 130, a textual features extractor 140, a text-based prediction model 150, and an outcome predictor 160. Generally, the sentiment-based tag extractor 120 may extract sentiment tags from comments, and the sentiment-based prediction model 130 may be applied to those tags. Analogously, the textual features extractor 140 may extract keywords (i.e., textual features) from the comments, and the text-based prediction model 150 may be applied to those keywords. The outcome predictor 160 may take as input the result of the sentiment-based prediction model 130 and the result of the text-based prediction model 150, and may thus predict an outcome of the project. The various components depicted may include software, hardware, or a combination of both.

A technical challenge of predicting a project outcome is choosing the right portion of comments, and selecting and combining textual and other derived features from comments. In existing systems, using textual comments and text classification does not yield in a high-quality predictor model. Thus, some embodiments of this disclosure combine textual features with tag-related features of textual comments, using sentiment tags. This approach may achieve superior prediction accuracy compared to using text-based classification approaches alone. Sentiment tags may enable the prediction system 100 to incorporate into its predictions the sentiment and semantic meaning of comments, as opposed to considering only the specific words being used.

Some embodiments of the prediction system 100 may operate in association with a project management system for managing projects 110, including managing project proposals, for example. Within the project management system, users may enter comments relating to the project 110. In general, these comments may be textual and may indicate facts about the project 110 or the users' thoughts on the project 110. From those comments, the prediction system 100 may predict an outcome of the project 110. More specifically, output from the prediction system 100 may be interpreted as selection of a particular outcome from a predetermined set of possible outcomes. These possible outcomes may be, for example, project proposal accepted, project proposal rejected, project within budget, and project over budget.

To this end, the prediction system 100 may calculate a set of probability scores, with each probability score in the set being associated with the likelihood of an associated outcome in the set of possible outcomes. It will be understood that a probability score need not be output for each possible outcome, in some embodiments. For example, and not by way of limitation, if the set of possible outcomes includes two possible outcomes, the prediction system 100 may output a single probability score for the first of such two possible outcomes, and that single probability score may thus imply the probability of the other possible outcome. In some embodiments, the prediction system 100 may interpret this calculated set of probability scores as selection of the possible outcome with the highest probability score in the set, and may thus output this selected outcome as the prediction. In some other embodiments, the prediction system 100 may output the set of probability scores, thus allowing a user to interpret the scores as desired.

In some embodiments, multiple sets of possible outcomes may be available, and the prediction system 100 may select a particular outcome from each set (e.g., by calculating a set of probability scores). For example, the prediction system 100 may select one outcome from the set of {project proposal accepted, project proposal rejected} and one from the set of {project within budget, and project over budget}.

The prediction system 100 may train one or more of its various predictor models, including, for example, the sentiment-based prediction model 130, the text-based prediction model 150, and the outcome predictor 160. This training may be based on training data, which may be historical data related to past projects 110 for which outcomes are already decided. The training data may include, from each of a collection of previous projects, a set of comments and at least one outcome. The sentiment-based prediction model 130 may be trained on tags, which are extracted from the comments, and outcomes of previous projects 110. In contrast, the text-based prediction model 150 may be trained on the keywords, which are extracted from the comments, and outcomes of previous projects 110. The outcome predictor 160 may be trained on the outputs of the sentiment-based prediction model 130 and the text-based prediction model 150, as well as the project outcomes.

To train the sentiment-based prediction model 130, the prediction system 100 may use two or more sets of sentiment tags and resulting outcomes, from two or more past projects 110. Using the sentiment-based tag extractor 120, these sentiment tags may be extracted from the comments before training on those comments.

In some embodiments, a sentiment tag may be a tuple, which may include three variables: an entity, a sentiment phrase, and an object. Thus, the sentiment-based tag extractor 120 may extract a sentiment tag from a comment by extracting a set of these three variables. In some embodiments, the various potential values of one or more of these variables may be pre-defined in a vocabulary. For example, and not by way of limitation, entities may include the company working on the project (e.g., preparing the current project proposal); competitor companies, partners, stakeholders, and customers; events; related projects; and the current project. For example, and not by way of limitation, objects may include references to the current or other projects, resources, solutions, and costs. A vocabulary of sentiment phrases may include phrases that relate possible entities to possible objects.

In some embodiments, sentiment tags may be extracted from comments using existing mechanisms of semantic analysis. For example, sentiment analysis may be used to identify a relationship between an entity and an object found in the comments, and to assign an applicable sentiment phrase from the vocabulary based on the relationship between the entity and object in the comment. The assigned sentiment phrase need not match the exact wording in the comment but, rather, may be determined to be equivalent based on semantic analysis or other types of analysis.

A comment may include one or multiple sentiment tags, which may be identified by the prediction system 100. In some embodiments, however, the prediction system 100 may summarize a comment's multiple sentiment tags into a single, comment-level sentiment tag. In such embodiments, semantic analysis may be used for this purpose, and later analyses of tags, discussed below, may then apply only to the comment-level tags.

The prediction system 100 may assign a sentiment score, which may be numerical, to each sentiment tag or, more specifically, to the sentiment phrase of each sentiment tag. In some embodiments, a sentiment score may be indicative of how positive or negative is the sentiment phrase of the sentiment tag in question. In other words, the sentiment score may indicate the strength and polarity of the sentiment tag in question. For example, in some embodiments, each sentiment tag may be assigned a score from −1 to 1, inclusively, where the absolute value of the sentiment score may indicate the strength of the sentiment phrase, and where positive scores may represent a positive polarity while negative scores may represent a negative polarity.

The prediction system 100 may define a sentiment mapping function that maps a sentiment phrase to a sentiment score representing that sentiment phrase. The sentiment mapping function may map each identified sentiment tag (e.g., of the three variables: entity, sentiment phrase, and object) to a sentiment score (e.g., in the range of −1 to 1). In some embodiments, the mapping may be table-based. In other words, the score associated with each sentiment phrase may be pre-defined. Thus, if a sentiment tag includes a certain sentiment phrase, the prediction system 100 may refer to the table to determine the sentiment score for that sentiment phrase and sentiment tag. It will be understood that other mechanisms for mapping sentiment tags to sentiment scores may also be used.

In some further embodiments, the prediction system 100 may apply a decay function to the sentiment scores, such that more recent comments within a project 110 are weighted more heavily than less recent comments within that same project 110. The set of comments related to a project may be viewed as a sequence of comments, with comments being ordered chronologically within the sequence. In this case, the decay function may apply to the sequence such that the weight of comments gets smaller as one moves from the recent end of the sequence to the least recent end. In some embodiments, for example, the weight given to each comment may vary from week to week, giving each of the most recent week's comments a weight of 1, each of the previous week's comments a weight of 0.9, each of the comments from the week before that a weight of 0.8, and so forth. For another example, the decay function may indicate an exponential change of the weights over time. The sentiment score assigned to a comment may be modified by the comment's weight to result in a weighted sentiment score. For example, a comment's weighted sentiment score may be the product of the comment's sentiment score and its weight. Thus, a weighted sentiment score may indicate the strength and positivity (or negativity) of the comment, tempered by the passage of time. In some embodiments, some comments may be so old that, given the decay function, the weight applied to those comments is zero. In that case, those comments may be removed from consideration. The decay function may therefore effectively be used to select which comments are being considered for training and for prediction purposes, and to what degree those comments are being considered. In other words, the decay function may effectively be used to select a best predictive subset of the comments for training and prediction purposes.

The prediction system 100 may perform a correlation analysis to build a tag-to-outcome mapping model to be used as the sentiment-based prediction model 130. The correlation analysis may determine correlations between {sentiment tag, weighted sentiment score} pairs and outcomes, where each project 110 in the training data includes a set of one or more {sentiment tag, weighted sentiment score} pairs from various comments and a set of one or more outcomes. This correlation analysis may result in the sentiment-based prediction model 130.

Thus, after training, the sentiment-based prediction model 130 may map each set of {sentiment tag, weighted sentiment score} pairs to one or more outcomes selected from one or more sets of possible outcomes. More specifically, after training, the sentiment-based prediction model 130 may map each set of {sentiment tag, weighted sentiment score} pairs to one or more sets of probability scores, with each set of probability scores corresponding to a set of possible outcomes.

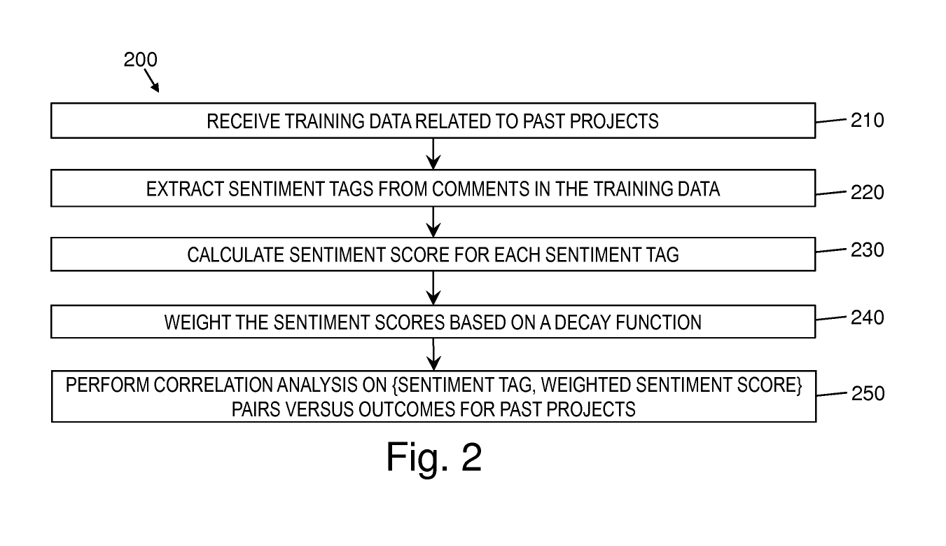

FIG. 2 is a flow diagram of a method 200 for training the sentiment-based prediction model 130, according to some embodiments of this disclosure. As shown, at block 210, training data is received related to one or more past projects 110, including comments and outcomes of those past projects 110. At block 220, sentiment tags may be extracted from the comments in the training data. At block 230, a sentiment score may be calculated for each sentiment tag. At block 240, the sentiment scores may be weighted based on a decay function. At block 250, correlation analysis may be performed to map {sentiment tag, weighted sentiment score} pairs to outcomes, thus providing the sentiment-based prediction model 130. It will be understood that other methods are also within the scope of this disclosure.

To train the text-based prediction model 150, the prediction system 100 may select key phrases from the comments of the past projects represented by the training data. Each key phrase may include one or more words. Finding the key phrases may be performed by the textual features extractor 140 using many mechanisms known in the art, including, for example, textual feature extraction in the form of n-grams.

After key phrases are identified, in some embodiments, the prediction system 100 may group similar key phrases together, such as by use of a semantic-based clustering algorithm, which may consider the semantic relationship among words and terms in a specific context to cluster them. In this case, the specific context under which the semantic relationship is considered may be the context of domain vocabularies and domain ontologies used for grouping similar words. Many clustering algorithms are known in the art and would be appropriate for the various embodiments of the prediction system 100. Key phrases that are clustered together for a single project 110 may be treated as a single representative key phrase or term. Thus, the data representing a particular past project, when used for the training, may include various terms or representative key phrases, each representing a group of like key phrases.

The text-based prediction model 150 may be trained on sets of terms, or representative key phrases, and outcomes, where each past project is represented in the training by a set of one or more terms and a set of one or more outcomes related to that past project. In some embodiments, the prediction system 100 may use correlation analysis on the terms and associated outcomes, resulting in a text-based prediction model 150 that maps terms from a project to one or more predicted outcomes selected from one or more sets of possible outcomes. More specifically, after training, the text-based prediction model 150 may map each set of terms to one or more sets of probability scores, with each set of probability scores corresponding to a set of possible outcomes.

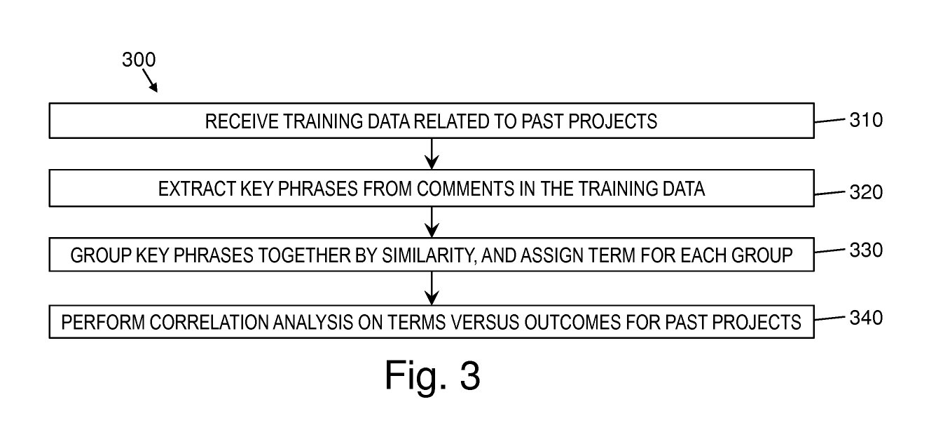

FIG. 3 is a flow diagram of a method 300 for training the text-based prediction model 150, according to some embodiments of this disclosure. As shown, at block 310, training data is received related to one or more past projects 110, including comments and outcomes of those past projects 110. At block 320, key phrases may be extracted from the comments in the training data. At block 330, the key phrases may be grouped together based on similarity, and assign a term to represent each group of similar key phrases. At block 340, correlation analysis may be performed to map the terms to outcomes, thus providing the text-based prediction model 150. It will be understood that other methods are also within the scope of this disclosure.

The outcome predictor 160 may be trained based on the results of the sentiment-based prediction model 130 and the text-based prediction model 150, combined with the outcomes of the past projects of the training data. Although the sentiment-based prediction model 130 and the text-based prediction model 150 were trained on the training data, more accurate results may be achieved by using these models 130 and 150 in combination. The outputs of the sentiment-based prediction model 130 and the text-based prediction model 150 may be considered intermediate predictions, or intermediate outcomes, which may be input into the outcome predictor 160 to determine a final prediction for a project 110 in question.

In some embodiments, the prediction system 100 may use linear regression analysis of the training data to determine how the intermediate prediction of the sentiment-based prediction model 130 and the intermediate prediction of the text-based prediction model 150 for the training data map to actual outcomes in the training data. In this manner, the outcome predictor 160 may determine weights applicable to these intermediate predictions, with a first weight applicable to the intermediate prediction of the sentiment-based prediction model 130 and a second weight applicable to the intermediate prediction of the text-based prediction model 150. These weights may correspond to the probabilities at which the sentiment-based prediction model 130 and the text-based prediction model 150 predict the correct outcomes. After training, these weights may be applied to the intermediate predictions of the sentiment-based prediction model 130 and the text-based prediction model 150 to determine one or more final predicted outcomes from one or more sets of possible outcomes.

More specifically, for each set of possible outcomes from which the prediction system 100 is configured to choose one predicted outcome, the sentiment-based prediction model 130 and the text-based prediction model 150 may each calculate one or more sets of probability scores as an intermediate prediction. Each set of probability scores output by one of the models 130 or 150 may indicate the probabilities of achieving various outcomes within a corresponding set of possible outcomes. In the case where a model 130 or 150 outputs more than a single set of probability scores, each set of probability scores may correspond to a set of possible outcomes from which the prediction system 100 is intended to select one. Thus, multiple sets of probability scores may lead to predictions from multiple sets of outcomes. The outcome predictor 160 may apply the first weight and the second weight to the sets of probability scores from the sentiment-based prediction model 130 and the text-based prediction model 150, thus resulting in one or more final sets of probability scores representing a final prediction of the prediction system 100. For example, and not by way of limitation, the outcome predictor 160 may apply the first and second weights in calculating a weighted average for each probability score in the one or more sets of probability scores received from the sentiment-based prediction model 130 and the text-based prediction model 150. Each final set of probability scores may be interpreted as a final selection of a possible outcome from among a set of possible outcomes.

After training is completed, the prediction system 100 may be configured to analyze comments for a project 110, and may thus predict an outcome of that project, such as by selecting one or more outcomes from one or more sets of possible outcomes.

Given comments for a project 110, the sentiment-based tag extractor 120 may extract sentiment tags from those comments and calculate a sentiment score for each sentiment tag. In some embodiments, the sentiment tags for each single comment may be combined into a comment-level sentiment tag, as discussed above. The sentiment scores may be weighted, as discussed above, and the set of {sentiment tag, sentiment score} pairs for the project may be input into the trained sentiment-based prediction model 130, which may output an intermediate prediction (e.g., in the form of probability scores).

Additionally, given the comments for the same project 110, the textual features extractor 140 may extract key phrases from those comments, and those key phrases may be grouped into a set of terms. The grouping may be achieved by a clustering algorithm, in some embodiments. As discussed above, each term may represent a group of similar key phrases extracted from the comments. The set of terms for the project may be input into the trained text-based prediction model 150, which may output an intermediate prediction (e.g., in the form of probability scores).

The outcome predictor 160 may take as input the intermediate predictions of the sentiment-based prediction model 130 and the text-based prediction model 150 (e.g., one or more sets of probability scores from each model 130 and 150), and may determine a final prediction. This final prediction may be output, for example, in the form of one or more sets of probability scores or in the form of one or more outcomes for the project 110. The prediction system 100 may thus determine that these one or more outcomes in the final set are the predicted outcomes for the project 110.

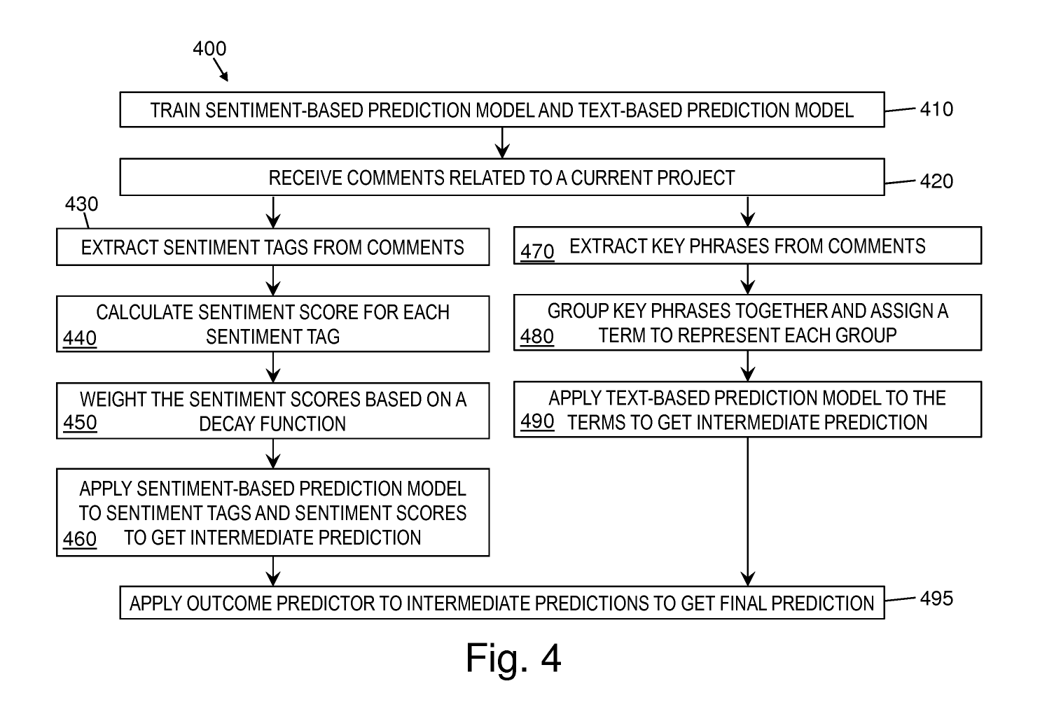

FIG. 4 is a flow diagram of a method 400 for predicting a project's outcome, according to some embodiments of this disclosure. As shown, at block 410, the sentiment-based prediction model 130 and the text-based prediction model 150 may be trained on training data related to past projects 110. At block 420, comments are received related to a current project 110. At block 430, sentiment tags may be extracted from those comments. At block 440, a sentiment score may be calculated for each sentiment tag. At block 450, the sentiment scores may be weighted based on a decay function. At block 460, sentiment-based prediction model 130 may be applied to the sentiment tags and scores to produce an intermediate prediction. At block 470, key phrases may be extracted from the comments related to the current project. At block 480, the key phrases may be grouped together by similarity, and a term may be assigned to represent each group of similar key phrases. At block 490, the text-based prediction model 150 may be applied to the terms to produce another intermediate prediction. At block 495, a final set of one or more outcomes may be determined by the outcome predictor 160, based on the two intermediate predictions from the sentiment-based prediction model 130 and the text-based prediction model 150. It will be understood that other methods are also within the scope of this disclosure.

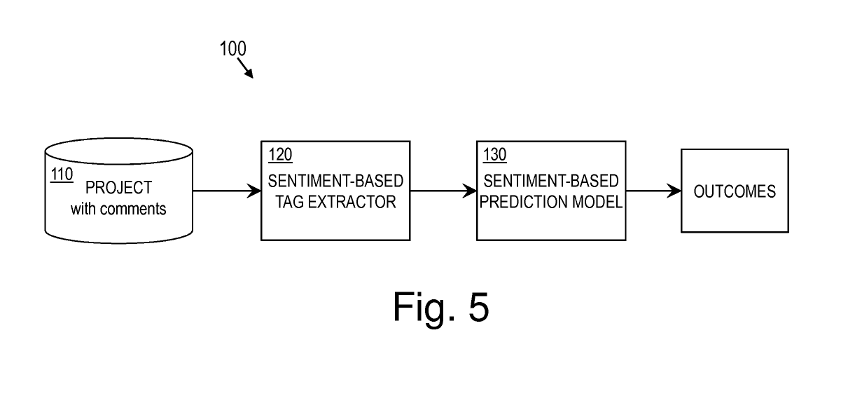

FIG. 5 is a block diagram of an alternative prediction system 100, according to some embodiments of this disclosure. Embodiments of the prediction system 100 according to FIG. 5 may exclude the text-based prediction model 150. As a result, the outcome predictor 160 may also be removed, or may be set to always output the intermediate prediction of the sentiment-based prediction model 130. While embodiments of the prediction system 100 according to FIG. 5 may provide decent results, based on sentiment analysis, they may prove to be less accurate than prediction systems 100 that combine the sentiment-based prediction model 130 with the text-based prediction model 150.

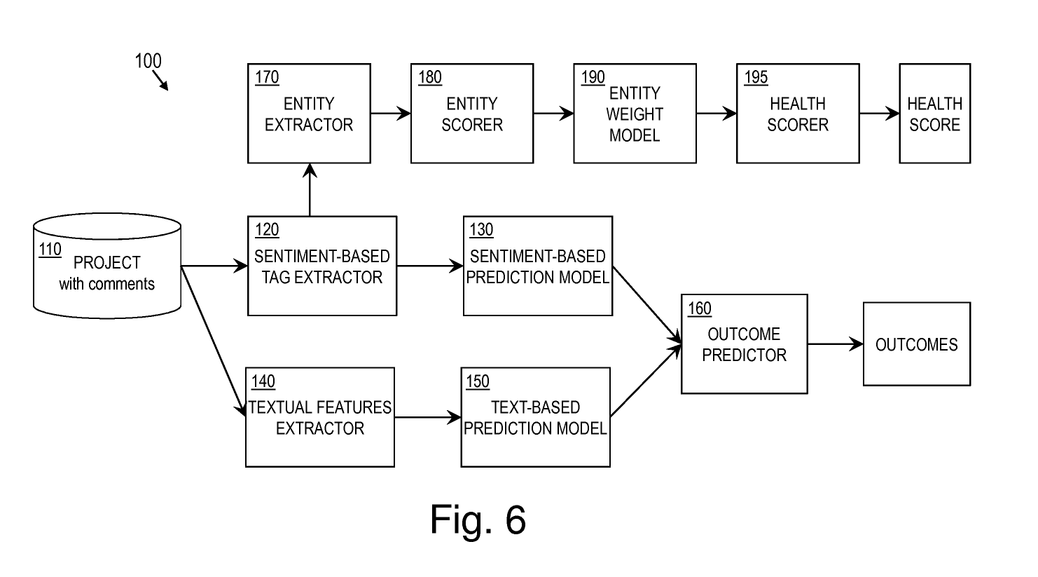

FIG. 6 is a block diagram of another prediction system 100, according to some embodiments of this disclosure. Some embodiments according to FIG. 6 may include the components described with respect to FIG. 1. As shown, the prediction system 100 may further include an entity extractor 170, an entity scorer 180, an entity weight model 190, and a project scorer 195. Generally, the entity extractor 170 may identify entities in a set of comments and, as needed, may construct a status tag for each entity to represent a history of the entity; the entity scorer 180 may calculate an entity score for each entity; the entity weight model 190 may determine an entity weight for each entity; and the health scorer 195 may score the project 110 as a whole based on information determined about the entities. The entity extractor 170, entity scorer 180, entity weight model 190, and health scorer 195 may include hardware, software, or a combination of both.

While it may be useful to predict an outcome for a project 110, as discussed above, it may also be useful to have an early warning system that determines a health status of a project 110. Thus, some embodiments of the prediction system 100 may calculate a health score to represent a project's health status. A health score may represent a general mood of the project 110, indicating how well the project 110 appears to be doing. While the health score need not be a predictor, it may play a role in how the project 110 is evaluated.

As discussed above with respect to extracting sentiment-based tags, the prediction system 100 may be capable of identifying entities within comments. For the purpose of determining a health score, this entity extraction may be performed by the entity extractor 170 of the prediction system 100. In some embodiments, however, the entity extractor 170 be part of, or in communication with, the sentiment-based tag extractor 120, which may also be configured to extract entities from comments. Each entity in the vocabulary may be associated with a status tag, which may represent the history of the entity in the historical data. In some embodiments, the prediction system 100 may maintain a status tag for each entity in the vocabulary of entities. Additionally or alternatively, the prediction system 100 may build a status tag for an entity as needed, and need not store the status tag for future use. For example, for each past project described in the historical data, a status tag of an entity may include an indication of the outcome (e.g., approved or not approved, won or lost) of a past project 110 as well as how many times the entity was mentioned in the comments of that past project 110.

The prediction system 100 may assign an entity score to each entity identified in comments of the historical data. This entity score may be based on the status tag of the entity, the historical data related to the entity, or a combination thereof More specifically, in some embodiments, an entity's entity score may be based on a weighted sum of a set of sentiment scores associated with the entity. For example, and not by way of limitation, the entity score may be the weighted sum or may be a weighted average of the set of sentiment scores. As discussed above, a sentiment score may be determined based on a sentiment phrase. For each reference to the entity in the comments of the historical data, a sentiment phrase may be identified as applicable to the entity within that comment. The sentiment score of that sentiment phrase may be used as the sentiment score of the entity as well. Each sentiment score may range from −1 to 1, inclusively. When an entity's sentiment score is negative, this may suggest a negative mood of the sentiment phrase and thus a negative mood associated with the entity. Analogously, when an entity's sentiment score is positive, this may suggest a positive mood of the sentiment phrase and thus a positive mood associated with the entity. The absolute value of a sentiment score may indicate the strength of the positive or negative mood associated with the entity.

As discussed above, the entity score for an entity may be based on a weighted sum of the various sentiment scores of references to the entity in the historical data. The weights for each sentiment score may be determined based on a decay function, such that references in more recent comments within a project 110 are weighted more heavily than those in less recent comments within the same project 110. This decay function may be the same or similar to the one described above.

The set of comments referencing an entity may be viewed as a sequence, with the comments being ordered chronologically within the sequence. In this case, the decay function may apply to the sequence such that the weight of entity references gets smaller as one moves from the recent end of the comment sequence to the least recent end. The sentiment score assigned to an entity reference made in a comment may be modified by the reference's weight (i.e., the comment's weight) to result in a weighted sentiment score. Thus, a reference's weighted sentiment score may be the product of its sentiment score and its comment's weight. A weighted sentiment score may indicate the strength and positivity (or negativity) of the reference to the entity, tempered by the passage of time.

In some embodiments, one or more comments may be so old that, given the decay function, the weight applied to references in those comments is zero. In that case, those entity references may be removed from consideration. The decay function may therefore effectively be used to select which references are being considered for training and for health score calculation, and to what degree those references are being considered. In other words, the decay function may effectively be used to select a best predictive subset of the comments for training and prediction purposes.

Using the decay function to weight the sentiment scores applicable to an entity, the prediction system 100 may calculate the total entity score based on a weighted sum of the sentiment scores. In other words, in determining the entity score, each sentiment score may be multiplied by a coefficient determined by the decay function.

The prediction system 100 may train the entity weight model 190 based on the entity scores and the status tags of various entities. In some embodiments, this training may be performed by way of a classification method. Based on this training, the entity weight model 190 may be configured to determine an entity weight for an entity based on the associated entity score and status tag.

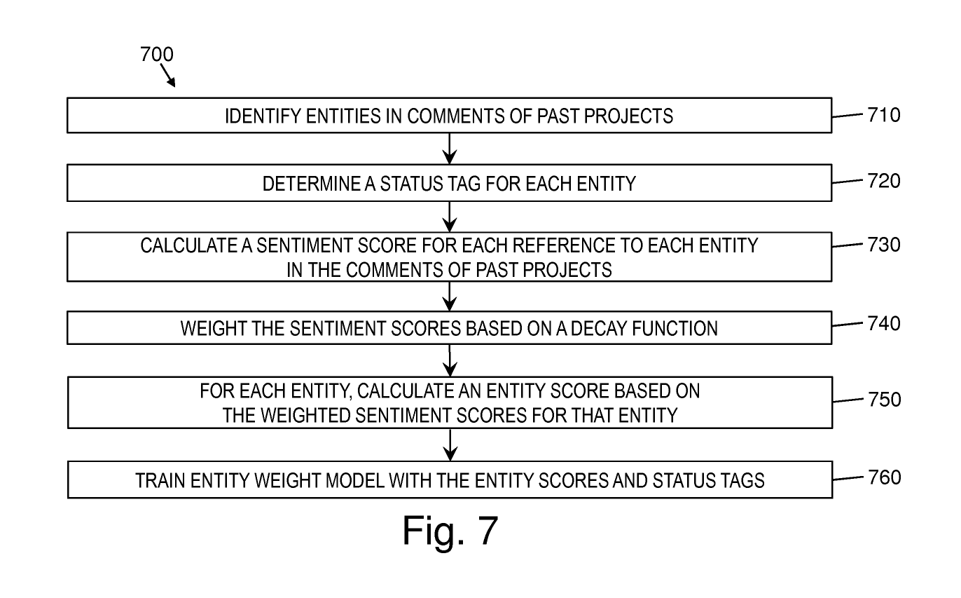

FIG. 7 is a flow diagram of a method 700 for training an entity weight model 190, according to some embodiment of this disclosure. As shown, at block 710, one or more entities may be identified in comments of one or more past projects in historical data. At block 720, a status tag may be determined for each entity, based on the past projects in which the entity is referenced. For example, the status tag may be constructed based on the historical data, or the status tag may have been previously constructed and may be located in storage. At block 730, a sentiment score may be calculated for each reference to each entity in the comments of the historical data. At block 740, these sentiment scores may be weighted based on a decay function. At block 750, for each entity, the weighted sentiment scores for the entity may be used to calculate an entity score. At block 760, the entity scores and status tags for the various entities may be used to train the entity weight model 190, such that the entity weight model may later output an entity weight when given an entity score and status tag.

The prediction system 100 may use the trained entity weight model 190 in determining a health score of a current project 110. To this end, the prediction system 100 may identify some or all entities referenced in the comments of the current project 110. For each entity, the prediction system 100 may locate or construct an associated status tag, based on past projects in the historical data, and may calculate an entity score. As discussed above, the entity score may be calculated as the sum of weighted sentiment scores related to the entity. In some embodiments, the entity scores may be saved and need not be calculated for each current project 110. Additionally, for each entity, the prediction system 100 may determine the entity weight. The entity weight may be determined by inputting the entity score and status tag into the entity weight model 190, which may output the entity weight.

For each reference to an entity in the comments of the current project 110, the prediction system 100 may calculate an entity reference score, which may be the entity weight of the entity referenced multiplied by the sentiment score of that reference.

The health score may be calculated based on a weighted sum of the entity reference scores for each entity reference in the comments of the current project 110. For example, and not by way of limitation, the health score may be the weighted sum or may be a weighted average of the entity reference scores. The weights for each entity reference score may be determined based on a decay function, such that references in more recent comments of the current project 110 are weighted more heavily than those in less recent comments. This decay function may be the same or similar to the one described above. Thus, the health score may incorporate references to various entities in the comments, and these references may be weighted to account for when they were made and the importance of the entities.

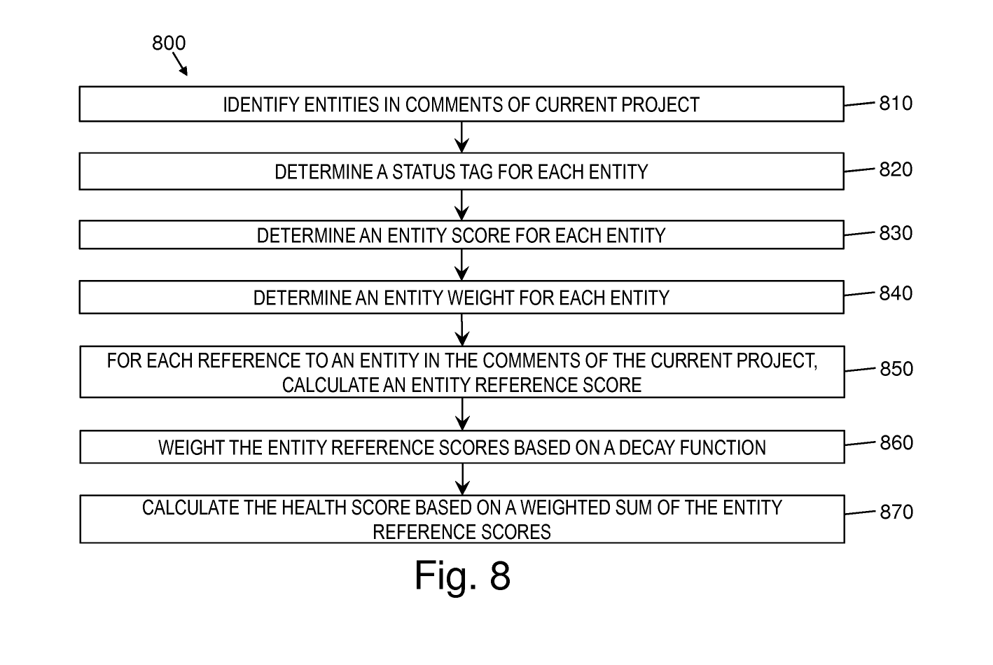

FIG. 8 is a flow diagram of a method 800 for calculating a project's health score, according to some embodiments of this disclosure. As shown, at block 810, one or more entities may be identified in the comments of a current project 110. At block 820, a status tag may be determined for each entity. At block 830, an entity score may be determined for each entity. At block 840, an entity weight may be determined for each entity. At block 850, for each reference to an entity in the comments of the current project 110, an entity reference score may be calculated as the entity weight of the entity being referenced multiplied by the sentiment score of the reference. At block 860, the entity reference scores may be weighted based on a decay function. At block 870, the health score of the current project 110 may be calculated based on a weighted sum of the entity reference scores associated with the project 110.

Although, in some embodiments, the health score does not predict an outcome for the project 110, it may be a useful tool in determining how well the project 110 is going. For example, if a current project 110 has a relatively low health score, an administrator may work to get more entities with high entity weights involved in the project in positive ways.

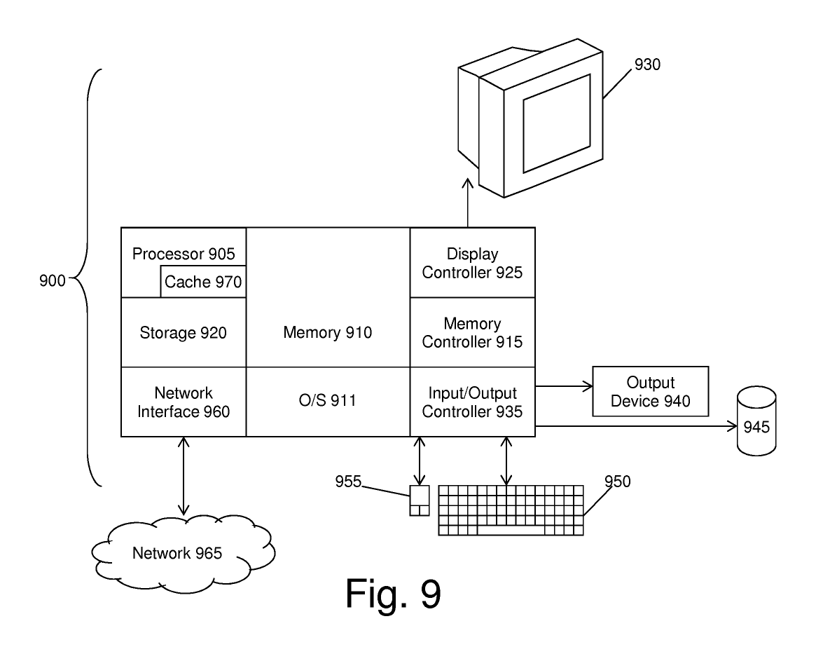

FIG. 9 illustrates a block diagram of a computer system 900 for use in implementing a prediction system or method according to some embodiments. The prediction systems and methods described herein may be implemented in hardware, software (e.g., firmware), or a combination thereof. In an exemplary embodiment, the methods described may be implemented, at least in part, in hardware and may be part of the microprocessor of a special or general-purpose computer system 900, such as a personal computer, workstation, minicomputer, or mainframe computer.

In an exemplary embodiment, as shown in FIG. 9, the computer system 900 includes a processor 905, memory 910 coupled to a memory controller 915, and one or more input devices 945 and/or output devices 940, such as peripherals, that are communicatively coupled via a local I/O controller 935. These devices 940 and 945 may include, for example, a printer, a scanner, a microphone, and the like. A conventional keyboard 950 and mouse 955 may be coupled to the I/O controller 935. The I/O controller 935 may be, for example, one or more buses or other wired or wireless connections, as are known in the art. The I/O controller 935 may have additional elements, which are omitted for simplicity, such as controllers, buffers (caches), drivers, repeaters, and receivers, to enable communications.

The I/O devices 940, 945 may further include devices that communicate both inputs and outputs, for instance disk and tape storage, a network interface card (NIC) or modulator/demodulator (for accessing other files, devices, systems, or a network), a radio frequency (RF) or other transceiver, a telephonic interface, a bridge, a router, and the like.

The processor 905 is a hardware device for executing hardware instructions or software, particularly those stored in memory 910. The processor 905 may be any custom made or commercially available processor, a central processing unit (CPU), an auxiliary processor among several processors associated with the computer system 900, a semiconductor based microprocessor (in the form of a microchip or chip set), a macroprocessor, or other device for executing instructions. The processor 905 includes a cache 970, which may include, but is not limited to, an instruction cache to speed up executable instruction fetch, a data cache to speed up data fetch and store, and a translation lookaside buffer (TLB) used to speed up virtual-to-physical address translation for both executable instructions and data. The cache 970 may be organized as a hierarchy of more cache levels (L1, L2, etc.).

The memory 910 may include any one or combinations of volatile memory elements (e.g., random access memory, RAM, such as DRAM, SRAM, SDRAM, etc.) and nonvolatile memory elements (e.g., ROM, erasable programmable read only memory (EPROM), electronically erasable programmable read only memory (EEPROM), programmable read only memory (PROM), tape, compact disc read only memory (CD-ROM), disk, diskette, cartridge, cassette or the like, etc.). Moreover, the memory 910 may incorporate electronic, magnetic, optical, or other types of storage media. Note that the memory 910 may have a distributed architecture, where various components are situated remote from one another but may be accessed by the processor 905.

The instructions in memory 910 may include one or more separate programs, each of which comprises an ordered listing of executable instructions for implementing logical functions. In the example of FIG. 9, the instructions in the memory 910 include a suitable operating system (OS) 911. The operating system 911 essentially may control the execution of other computer programs and provides scheduling, input-output control, file and data management, memory management, and communication control and related services.

Additional data, including, for example, instructions for the processor 905 or other retrievable information, may be stored in storage 920, which may be a storage device such as a hard disk drive or solid state drive. The stored instructions in memory 910 or in storage 920 may include those enabling the processor to execute one or more aspects of the prediction systems and methods of this disclosure.

The computer system 900 may further include a display controller 925 coupled to a display 930. In an exemplary embodiment, the computer system 900 may further include a network interface 960 for coupling to a network 965. The network 965 may be an IP-based network for communication between the computer system 900 and any external server, client and the like via a broadband connection. The network 965 transmits and receives data between the computer system 900 and external systems. In an exemplary embodiment, the network 965 may be a managed IP network administered by a service provider. The network 965 may be implemented in a wireless fashion, e.g., using wireless protocols and technologies, such as WiFi, WiMax, etc. The network 965 may also be a packet-switched network such as a local area network, wide area network, metropolitan area network, the Internet, or other similar type of network environment. The network 965 may be a fixed wireless network, a wireless local area network (LAN), a wireless wide area network (WAN) a personal area network (PAN), a virtual private network (VPN), intranet or other suitable network system and may include equipment for receiving and transmitting signals.

Prediction systems and methods according to this disclosure may be embodied, in whole or in part, in computer program products or in computer systems 900, such as that illustrated in FIG. 9.

Technical effects and benefits of some embodiments are improved mechanisms for predicting project outcomes, by combining sentiment analysis with analysis of key phrases. As a result, predictions can be improved by the combination of two predictors that focus on different aspects of project-related comments.

The terminology used herein is for the purpose of describing particular embodiments only and is not intended to be limiting of the invention. As used herein, the singular forms “a”, “an” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof.

The corresponding structures, materials, acts, and equivalents of all means or step plus function elements in the claims below are intended to include any structure, material, or act for performing the function in combination with other claimed elements as specifically claimed. The description of the present invention has been presented for purposes of illustration and description, but is not intended to be exhaustive or limited to the invention in the form disclosed. Many modifications and variations will be apparent to those of ordinary skill in the art without departing from the scope and spirit of the invention. The embodiments were chosen and described in order to best explain the principles of the invention and the practical application, and to enable others of ordinary skill in the art to understand the invention for various embodiments with various modifications as are suited to the particular use contemplated.

The present invention may be a system, a method, and/or a computer program product. The computer program product may include a computer readable storage medium (or media) having computer readable program instructions thereon for causing a processor to carry out aspects of the present invention.

The computer readable storage medium can be a tangible device that can retain and store instructions for use by an instruction execution device. The computer readable storage medium may be, for example, but is not limited to, an electronic storage device, a magnetic storage device, an optical storage device, an electromagnetic storage device, a semiconductor storage device, or any suitable combination of the foregoing. A non-exhaustive list of more specific examples of the computer readable storage medium includes the following: a portable computer diskette, a hard disk, a random access memory (RAM), a read-only memory (ROM), an erasable programmable read-only memory (EPROM or Flash memory), a static random access memory (SRAM), a portable compact disc read-only memory (CD-ROM), a digital versatile disk (DVD), a memory stick, a floppy disk, a mechanically encoded device such as punch-cards or raised structures in a groove having instructions recorded thereon, and any suitable combination of the foregoing. A computer readable storage medium, as used herein, is not to be construed as being transitory signals per se, such as radio waves or other freely propagating electromagnetic waves, electromagnetic waves propagating through a waveguide or other transmission media (e.g., light pulses passing through a fiber-optic cable), or electrical signals transmitted through a wire.

Computer readable program instructions described herein can be downloaded to respective computing/processing devices from a computer readable storage medium or to an external computer or external storage device via a network, for example, the Internet, a local area network, a wide area network and/or a wireless network. The network may comprise copper transmission cables, optical transmission fibers, wireless transmission, routers, firewalls, switches, gateway computers and/or edge servers. A network adapter card or network interface in each computing/processing device receives computer readable program instructions from the network and forwards the computer readable program instructions for storage in a computer readable storage medium within the respective computing/processing device.

Computer readable program instructions for carrying out operations of the present invention may be assembler instructions, instruction-set-architecture (ISA) instructions, machine instructions, machine dependent instructions, microcode, firmware instructions, state-setting data, or either source code or object code written in any combination of one or more programming languages, including an object oriented programming language such as Java, Smalltalk, C++ or the like, and conventional procedural programming languages, such as the “C” programming language or similar programming languages. The computer readable program instructions may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider). In some embodiments, electronic circuitry including, for example, programmable logic circuitry, field-programmable gate arrays (FPGA), or programmable logic arrays (PLA) may execute the computer readable program instructions by utilizing state information of the computer readable program instructions to personalize the electronic circuitry, in order to perform aspects of the present invention.

Aspects of the present invention are described herein with reference to flowchart illustrations and/or block diagrams of methods, apparatus (systems), and computer program products according to embodiments of the invention. It will be understood that each block of the flowchart illustrations and/or block diagrams, and combinations of blocks in the flowchart illustrations and/or block diagrams, can be implemented by computer readable program instructions.

These computer readable program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks. These computer readable program instructions may also be stored in a computer readable storage medium that can direct a computer, a programmable data processing apparatus, and/or other devices to function in a particular manner, such that the computer readable storage medium having instructions stored therein comprises an article of manufacture including instructions which implement aspects of the function/act specified in the flowchart and/or block diagram block or blocks.

The computer readable program instructions may also be loaded onto a computer, other programmable data processing apparatus, or other device to cause a series of operational steps to be performed on the computer, other programmable apparatus or other device to produce a computer implemented process, such that the instructions which execute on the computer, other programmable apparatus, or other device implement the functions/acts specified in the flowchart and/or block diagram block or blocks.

The flowchart and block diagrams in the Figures illustrate the architecture, functionality, and operation of possible implementations of systems, methods, and computer program products according to various embodiments of the present invention. In this regard, each block in the flowchart or block diagrams may represent a module, segment, or portion of instructions, which comprises one or more executable instructions for implementing the specified logical function(s). In some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts or carry out combinations of special purpose hardware and computer instructions.

The descriptions of the various embodiments of the present invention have been presented for purposes of illustration, but are not intended to be exhaustive or limited to the embodiments disclosed. Many modifications and variations will be apparent to those of ordinary skill in the art without departing from the scope and spirit of the described embodiments. The terminology used herein was chosen to best explain the principles of the embodiments, the practical application or technical improvement over technologies found in the marketplace, or to enable others of ordinary skill in the art to understand the embodiments disclosed herein.

What is claimed is:

1. A computer-implemented method comprising:
receiving a set of comments related to a project;
extracting one or more sentiment tags from the set of comments, wherein each sentiment tag comprises an associated sentiment phrase;
assigning one or more sentiment scores to the one or more sentiment tags, with a sentiment score being assigned to each associated sentiment tag, the sentiment score for an associated sentiment tag being selected to represent the strength and polarity of the associated sentiment phrase; and
mapping the one or more sentiment tags and the one or more sentiment scores to a first prediction for the project.

2. The method of claim 1, further comprising weighting the one or more sentiment scores, wherein the set of comments is chronologically ordered, wherein the sentiment scores are chronologically ordered, and wherein the sentiment scores are weighted based on the chronological order of the sentiment scores.

3. The method of claim 2, wherein weighting the one or more sentiment scores comprises applying a decay function to the sentiment scores according to the chronological order of the sentiment scores.

4. The method of claim 1, further comprising selecting a best predictive subset of the set of comments, wherein extracting the one or more sentiment tags from the set of comments comprises extracting the one or more sentiment tags from the best predictive subset of the set of comments.

5. The method of claim 1, wherein mapping the one or more sentiment tags and the one or more sentiment scores to the prediction is performed according to a sentiment-based prediction model, and wherein training the sentiment-based prediction model comprises:
receiving training data comprising past comments and past outcomes for one or more past projects;
extracting one or more past sentiment tags from the past comments, wherein each past sentiment tag comprises an associated past sentiment phrase;
assigning one or more past sentiment scores to the one or more past sentiment tags, with a past sentiment score being assigned to each associated past sentiment tag, the past sentiment score for an associated past sentiment tag being selected to represent the strength and polarity of the associated past sentiment phrase; and
applying correlation analysis to the one or more past sentiment tags, the one or more past sentiment scores, and the past outcomes of the one or more past projects.

6. The method of claim 1, further comprising:
extracting one or more key phrases from the set of comments;
mapping the one or more key phrases to a second prediction for the project; and
applying a first weight to the first prediction and a second weight to the second prediction, to result in a final prediction for the project.

7. The method of claim 1, further comprising:
identifying one or more entities referenced in the set of comments related to the project;
determining an entity score for each of the one or more entities, wherein a first entity score for a first entity is based on a weighted sum of one or more entity sentiment scores related to the first entity;
determining an entity weight for each of the one or more entities, wherein the entity weight of the first entity is based on the first entity score and a status tag of the first entity, wherein the status tag indicates a history of the first entity in one or more past projects;
calculating an entity reference score for each entity reference in the set of comments, wherein the entity reference score of a first entity reference is based on an entity weight of an entity being referenced and a sentiment score of the entity reference; and
calculating a health score of the project, wherein the health score is based on a weighted sum of the entity reference scores.

8. A system comprising:
a memory having computer readable instructions; and
a processor for executing the computer readable instructions, the computer readable instructions comprising:
receiving a set of comments related to a project;
extracting one or more sentiment tags from the set of comments, wherein each sentiment tag comprises an associated sentiment phrase;
assigning one or more sentiment scores to the one or more sentiment tags, with a sentiment score being assigned to each associated sentiment tag, the sentiment score for an associated sentiment tag being selected to represent the strength and polarity of the associated sentiment phrase; and
mapping the one or more sentiment tags and the one or more sentiment scores to a first prediction for the project.

9. The system of claim 8, the computer readable instructions further comprising weighting the one or more sentiment scores, wherein the set of comments is chronologically ordered, wherein the sentiment scores are chronologically ordered, and wherein the sentiment scores are weighted based on the chronological order of the sentiment scores.

10. The system of claim 9, wherein weighting the one or more sentiment scores comprises applying a decay function to the sentiment scores according to the chronological order of the sentiment scores.

11. The system of claim 8, the computer readable instructions further comprising selecting a best predictive subset of the set of comments, wherein extracting the one or more sentiment tags from the set of comments comprises extracting the one or more sentiment tags from the best predictive subset of the set of comments.

12. The system of claim 8, wherein mapping the one or more sentiment tags and the one or more sentiment scores to the first prediction is performed according to a sentiment-based prediction model, and wherein training the sentiment-based prediction model comprises:
receiving training data comprising past comments and past outcomes for one or more past projects;
extracting one or more past sentiment tags from the past comments, wherein each past sentiment tag comprises an associated past sentiment phrase;
assigning one or more past sentiment scores to the one or more past sentiment tags, with a past sentiment score being assigned to each associated past sentiment tag, the past sentiment score for an associated past sentiment tag being selected to represent the strength and polarity of the associated past sentiment phrase; and
applying correlation analysis to the one or more past sentiment tags, the one or more past sentiment scores, and the past outcomes of the one or more past projects.

13. The system of claim 8, the computer readable instructions further comprising:
identifying one or more entities referenced in the set of comments related to the project;
determining an entity score for each of the one or more entities, wherein a first entity score for a first entity is based on a weighted sum of one or more entity sentiment scores related to the first entity;
determining an entity weight for each of the one or more entities, wherein the entity weight of the first entity is based on the first entity score and a status tag of the first entity, wherein the status tag indicates a history of the first entity in one or more past projects;
calculating an entity reference score for each entity reference in the set of comments, wherein the entity reference score of a first entity reference is based on an entity weight of an entity being referenced and a sentiment score of the entity reference; and
calculating a health score of the project, wherein the health score is based on a weighted sum of the entity reference scores.

14. A computer program product for predicting a project outcome, the computer program product comprising a computer readable storage medium having program instructions embodied therewith, the program instructions executable by a processor to cause the processor to perform a method comprising:
receiving a set of comments related to a project;
extracting one or more sentiment tags from the set of comments, wherein each sentiment tag comprises an associated sentiment phrase;
assigning one or more sentiment scores to the one or more sentiment tags, with a sentiment score being assigned to each associated sentiment tag, the sentiment score for an associated sentiment tag being selected to represent the strength and polarity of the associated sentiment phrase; and
mapping the one or more sentiment tags and the one or more sentiment scores to a first prediction for the project.

15. The computer program product of claim 14, the method further comprising weighting the one or more sentiment scores, wherein the set of comments is chronologically ordered, wherein the sentiment scores are chronologically ordered, and wherein the sentiment scores are weighted based on the chronological order of the sentiment scores.

16. The computer program product of claim 15, wherein weighting the one or more sentiment scores comprises applying a decay function to the sentiment scores according to the chronological order of the sentiment scores.

17. The computer program product of claim 14, the method further comprising selecting a best predictive subset of the set of comments, wherein extracting the one or more sentiment tags from the set of comments comprises extracting the one or more sentiment tags from the best predictive subset of the set of comments.

18. The computer program product of claim 14, wherein mapping the one or more sentiment tags and the one or more sentiment scores to the first prediction is performed according to a sentiment-based prediction model, and wherein training the sentiment-based prediction model comprises:
receiving training data comprising past comments and past outcomes for one or more past projects;
extracting one or more past sentiment tags from the past comments, wherein each past sentiment tag comprises an associated past sentiment phrase;
assigning one or more past sentiment scores to the one or more past sentiment tags, with a past sentiment score being assigned to each associated past sentiment tag, the past sentiment score for an associated past sentiment tag being selected to represent the strength and polarity of the associated past sentiment phrase; and
applying correlation analysis to the one or more past sentiment tags, the one or more past sentiment scores, and the past outcomes of the one or more past projects.

19. The computer program product of claim 14, the method further comprising:
extracting one or more key phrases from the set of comments;
mapping the one or more key phrases to a second prediction for the project; and
applying a first weight to the first prediction and a second weight to the second prediction, to result in a final prediction for the project.

20. The computer program product of claim 14, the method further comprising:
identifying one or more entities referenced in the set of comments related to the project;
determining an entity score for each of the one or more entities, wherein a first entity score for a first entity is based on a weighted sum of one or more entity sentiment scores related to the first entity;
determining an entity weight for each of the one or more entities, wherein the entity weight of the first entity is based on the first entity score and a status tag of the first entity, wherein the status tag indicates a history of the first entity in one or more past projects;
calculating an entity reference score for each entity reference in the set of comments, wherein the entity reference score of a first entity reference is based on an entity weight of an entity being referenced and a sentiment score of the entity reference; and
calculating a health score of the project, wherein the health score is based on a weighted sum of the entity reference scores.
